(19) United States
(12) Patent Application Publication
(10) Pub. No.: US 2014/0167453 A1
(43) Pub. Date: Jun. 19, 2014

(54) VEHICLE BODY AND METHOD FOR MANUFACTURING A MOLDED PART

(71) Applicant: GM GLOBAL TECHNOLOGY OPERATIONS LLC, Detroit, MI (US)

(72) Inventors: Ronald SANDERS, Daxweiler (DE); Harmut Baumgart, Bischofsheim (DE)

(73) Assignee: GM GLOBAL TECHNOLOGY OPERATIONS LLC, Detroit, MI (US)

(21) Appl. No.: 14/109,430

(22) Filed: Dec. 17, 2013

(30) Foreign Application Priority Data
Dec. 17, 2012 (DE) 10 2012 024 626.9

(51) Int. Cl. B62D 25/00; B62D 25/08; B62D 25/04; B62D 25/02; C21D 8/00; C23C 2/02

(52) U.S. Cl. CPC B62D 25/00; C21D 8/005; C23C 2/02; B62D 25/04; B62D 25/025; B62D 25/08
USPC 296/203.01; 148/533

(57) ABSTRACT

A method for manufacturing a corrosion-protected steel molded part with an at least predominantly bainitic structure is provided. The method includes heating a blank of sheet steel to an austenization temperature; compression molding the blank while simultaneously cooling, so as to obtain a molded part; and bainitizing the molded part in a zinc coating bath.

### CROSS-REFERENCE TO RELATED APPLICATION

This application claims priority to German Patent Application No. 10 2012 024 626.9, filed Dec. 17, 2012, which is incorporated herein by reference in its entirety.

### TECHNICAL FIELD

The technical field relates to a method for manufacturing a corrosion-protected molded part out of steel, as well as to a vehicle body exhibiting such a molded part.

### BACKGROUND

The body of a motor vehicle should exhibit as low a weight as possible on the one hand, so as to minimize the fuel consumption of the motor vehicle, while ensuring the greatest possible safety for the vehicle passengers in the event of an impact event on the other. In order to achieve a high level of safety for the passengers in the vehicle, the wall thickness of the used metal sheets cannot be too thin. However, a large wall thickness also translates into a high weight for the body. As a result, a high level of safety can generally not be achieved without a high fuel consumption.

In recent years, a new class of steels has been introduced onto the market with the advent of so-called press-hardening steels (PHS steels), which make it possible to better achieve these mutually contradictory requirements. In order to manufacture molded parts out of these PHS steels, blanks fabricated out of the raw metal sheets are first heated to austenization temperature, and then cooled in a molding tool in the molding process. Simultaneous deformation and cooling yields molded parts with a pure or nearly pure martensitic structure, which reach extremely high strength values of 1300 MPa and above. Thanks to the extremely high strength of the molded parts fabricated out of these steels, small wall thicknesses and a correspondingly low weight of the molded parts are sufficient to achieve a prescribed load-bearing capacity for the body.

However, the high strength of these molded parts is associated with a relatively low ultimate elongation. If a vehicle whose body exhibits such molded parts becomes involved in an impact event, these high-strength molded parts may not deform as much as desired. As a result, the amount of collision energy that can be used up through deformation may be rather small.

DE 10 2008 022 399 A1 proposes a method for manufacturing a steel molded part in which a blank is first austenized in a furnace and then compression-molded while cooling as described above, but this cooling is only intended to proceed up to the bainitization temperature, and compression molding is followed by a bainitization treatment. The blank is already to be provided with an anti-corrosion metal coating prior to austenization, so as to protect it against oxidation by ambient oxygen already while transporting it from the furnace to the compression-molding tool. Bainitization can take place in a salt or lead bath, wherein it is especially recommended that the steel molded part be subjected to bainitization treatment in the compression-molding tool itself The tool closing time of the pressing tool inside of which the molded part is to be both shaped and bainitized should not exceed 60 seconds.

The time required by a molded part for cooling and bainitizing necessarily depends on the dimensions, in particular the wall thickness of the molded part. Therefore, it can be expected for thick-walled molded parts that the proposed time will not suffice, so that the time for which the molding tool is occupied for bainitization treatment can be significantly longer for such molded parts. The productivity of a molding tool is thus considerably restricted by the bainitization running its course therein, which increases the production costs. As additional treatment steps, the proposed salt or lead bath alternatives also result in higher costs.

In addition, other objects, desirable features and characteristics will become apparent from the subsequent summary and detailed description, and the appended claims, taken in conjunction with the accompanying drawings and this background.

### SUMMARY

Therefore, one of various aspects of the present disclosure is to provide a method that enables the manufacture of a steel molded part with a high ultimate elongation and strength at a low outlay.

In this regard, the present disclosure provides a method for manufacturing a corrosion-protected steel molded part with an at least predominantly bainitic structure involving the following steps: a) Heating a blank of sheet steel to an austenization temperature; b) Compression molding the blank while simultaneously cooling; and c) Bainitizing the compression-molded blank by having bainitization take place in a zinc coating bath.

As a consequence, since bainitization can take place concurrently with generating a corrosion protection layer via zinc coating, production can be accelerated. A prolonged blockade of a compression molding tool caused by a bainitization process underway therein is avoided, so that the compression molding tools can be operated at a high productivity. Because operating the zinc coating bath for the compression molded parts does not necessarily require more energy than conventional zinc coating prior to compression molding, and the lead or salt bath are eliminated, energy can also be economized during production. A higher quality for the finished molded parts can also be achieved, on the one hand because zinc coating after compression molding enables the generation of a seamless corrosion protection layer on the entire surface of the molded parts, and on the other hand through the elimination of problems associated with compression molding zinc coated metal sheets, such as liquid metal corrosion due to the zinc layer melting in the austenization process.

In contrast to a prolonged blocking of a molding tool, a long duration of bainitization in the zinc coating bath does not yield any noteworthy increase in costs, since the zinc coating bath, as opposed to the molding tool, can readily accommodate a plurality of molded parts at the same time.

Generally, the bainitization temperature should not be dropped below during compression molding.

In addition to zinc, the zinc coating bath in one example, also contains aluminum in an amount that lowers the melting point of the bath to below the melting point of pure zinc, and inhibits the formation of the ZnFe alloy layer. In one example, it can contain a eutectic alloy of zinc and aluminum, i.e., approx. 95% w/w zinc and approx. 5% w/w aluminum.

In such a zinc coating bath, zinc coating can take place at a temperature lower than the melting temperature of the pure zinc. This limits the tendency of the zinc to diffuse into the surface of the molded parts to be zinc coated and there form an Fe—Zn alloy layer, and even though the molded parts remain in the zinc coating bath longer for bainitization than required for zinc coating, the thickness of such a layer remains small.

Bainitization treatment at a higher temperature of the zinc coating bath facilitates a high expansion of the treated molded parts. Therefore, the temperature of the zinc coating bath should generally lie within a temperature range suitable for the formation of the upper bainite.

A percentage of magnesium and rare earth metals, in one example, cerium and lanthanum, in the zinc melt proves advantageous for limiting the growth of the Fe—Zn alloy layer, in particular given a high temperature of the zinc coating bath. The percentage of rare earth metals can range between about 0.1 and about 2% w/w; the ideal quantity can vary depending on the rare earth metals used and their relative percentages, with good results being achieved in particular with a percentage of about 1% w/w. The magnesium percentage can lie at about the same level.

To avoid a surface oxidation of the blanks in steps a) and/or b) that might impair the quality of subsequent zinc coating, step a) and/or step b) generally takes place under an inert or reducing atmosphere.

The blank is in one example, fabricated out of a press-hardening steel, in particular an MnB steel, or a heat treatable steel.

Another one of various aspects of the present disclosure is to provide a vehicle body that can dissipate high amounts of collision energy at a low weight, and thereby provide its passengers with effective protection in the event of an impact event. Also provided according to the various teachings of the present disclosure is a vehicle body that contains a molded part manufactured in the method described above as a component, especially as a component to be deformed during a collision. In one example, this component can be an A-, B- or C-pillar.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic view of a production line for implementing the method according to the various teachings of the present disclosure; and

FIG. 2 is a graph depicting the temperature distribution along the production line on FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The starting material for the method is a plate or steel strip 1, here cylindrical, comprising a heat treatable steel with C about 0.3 to about 0.5%, Se about 0.15% max., Mn about 0.9% max., P about 0.02% max., Mi about 0.15% max., Ti about 0.02% max., v about 0.05% max., Nb about 0.03% max., Al about 0.6% max., N about 0.15% max., Cu about 0.15% max., B about 8 ppm max., As about 0.04% max. and Sn about 0.02% max., remainder Fe with the unavoidable contaminants, or of a PHS steel, in one example, 22 MnB5 with C about 0.19% to about 0.27%, Mn about 1 to about 1.5%, Al≦about 0.01%, Si≦about 0.05%, P≦about 0.03%, S≦about 0.005%, Cr about 0.35%, Ti about 0.20% to about 0.055%, N≦about 0.10%, B about 0.0005% to about 0.004%.

Blanks 3 obtained from the steel strip 1 in an automatic cutting press 2 run through an austenization furnace 4, a compression molding tool 5 and then a zinc coating bath 6. The boundaries of an area in which the blanks 3 or molded parts 8 obtained from them are kept under a protective gas atmosphere is denoted on the figure by a dot-dashed rectangle 7. This area 7 here extends from the austenization furnace 4 up to an inlet area of the zinc coating bath 6. The molded parts 8 are in one example, supporting components of a motor vehicle body, which can be exposed to a high flexural load during an impact event, e.g., B-pillars in this case.

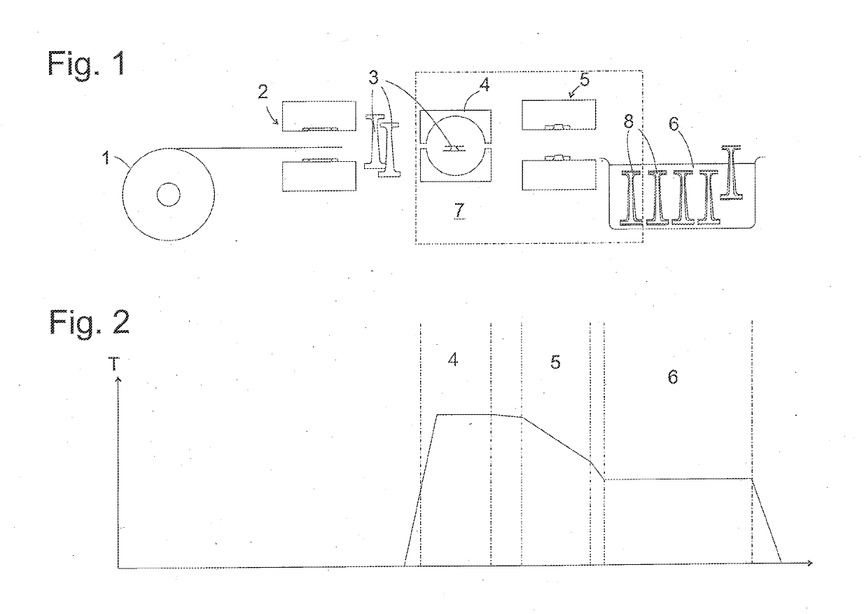

The graphs on FIG. 2 show areas corresponding to the various manufacturing stages on FIG. 1, each denoted by their reference number. When entering the austenization furnace 3, the blanks are heated to an austenization temperature. The latter measures approx. 900° C.; its exact value depends on the used grade of steel.

An austenized blank 3 is essentially loaded into the compression molding tool 5 without interim cooling, and cools off in the latter during the compression molding process. The temperature of a molded part 8 obtained from the blank 3 should not lie under 650° C. when exiting the compression molding tool.

A known treatment not shown here for activating the molded parts 8 before they enter into the zinc coating bath 6 can improve the uniformity of the zinc coating obtained in the zinc coating bath 6, and its adhesion to the surface of the molded parts 8.

When submerged in the zinc coating bath 6, the molded parts 8 quickly assume its temperature, and remain there until removed again. This temperature usually measures between about 420 and about 520° C., and thus lies reliably within the temperature range in which bainitization takes place.

A low temperature of the zinc coating bath 6 can be desirable to prevent the zinc from diffusing into the surface of the molded parts 8, or at least to limit the thickness of an Fe—Zn alloy layer that forms in the process, whose corrosion-inhibiting effect is inferior to that of an essentially nonferrous zinc coating layer. At the same time, a low temperature of the zinc coating bath 6 slows down bainitization, so that retention times of several minutes, typically approx. 10 minutes, are sufficient to reach a predominantly bainitic structure for the molded parts 8.

When using in one example, a eutectic Zn—Al alloy for the zinc coating bath 6, zinc coating can take place at a temperature as low as about 382° C. This temperature range is also suitable for bainitization. Using the Zn—Al alloy can minimize the thickness of the Fe—Zn alloy layer on the surface of the molded parts 8.

Zinc coating in the zinc coating bath 6 ensures that the molded parts 8, just like those manufactured out of a pre-zinc coated sheet steel, are not only protected against corrosion on their primary surfaces, but also on the cutting edges. This is especially advantageous if the molded parts are to be used as A-, B- or C-pillars in a motor vehicle body, which are exposed to a relatively high level of corrosion owing to moisture, in particular at their lower ends. The method can also be used for other body parts that might be subjected to a strong load during a collision, such as the frame, front and rear frame extension, tunnel cap, strike plates, cross members.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for manufacturing a corrosion-protected steel molded part with an at least predominantly bainitic structure, the method comprising the steps of:
heating a blank of sheet steel to an austenization temperature;
compression molding the blank of sheet steel while simultaneously cooling, so as to obtain a molded part; and
bainitizing the molded part,
wherein bainitization takes place in a zinc coating bath.

2. The method according to claim 1, wherein the bainitization temperature is not dropped during compression molding.

3. The method according to claim 1, wherein the retention time of the steel molded part in the zinc coating bath measures at least 2 minutes.

4. The method according to claim 1, wherein the zinc coating bath contains zinc as well as aluminum in an amount that lowers the melting point of the zinc coating bath to below the melting point of pure zinc.

5. The method according to claim 3, wherein zinc coating takes place in a temperature range suitable for the formation of upper bainite.

6. The method according to claim 1, wherein the zinc coating bath exhibits a percentage of rare earth metals ranging between 0.1 and 2% w/w.

7. The method according to claim 1, wherein the zinc coating bath exhibits a percentage of magnesium ranging between 0.5 and 2% w/w.

8. The method according to claim 1, wherein heating the blank of sheet steel to the austenization temperature takes place under an inert or reducing atmosphere.

9. The method according to claim 1, wherein the blank of sheet steel is fabricated out of a press-hardening steel.

10. A vehicle body, comprising:
a molded part as a component of the vehicle body, the molded part comprising a corrosion-protected steel with an at least predominantly bainitic structure.

11. The vehicle body of claim 10, wherein the molded part is an A-, B- or C-pillar, a frame, a front or rear frame extension, a tunnel cap, a strike plate or a cross member.

12. The method according to claim 1, wherein the retention time of the steel molded part in the zinc coating bath measures at least 5 minutes.

13. The method according to claim 1, wherein compression molding the blank of sheet steel while simultaneously cooling takes place under an inert or reducing atmosphere.

14. The method according to claim 9, wherein the blank of sheet steel is fabricated out of 22MnB5.

15. The method according to claim 1, wherein the blank of sheet steel is fabricated out of a heat treatable steel.
